(19) United States
(12) Patent Application Publication
(10) Pub. No.: US 2007/0158464 A1
(43) Pub. Date: Jul. 12, 2007

(54) Texture spray gun

(76) Inventors: Diane L. Olson, Princeton, MN (US); Thomas E. Pauly, Zimmerman, MN (US); David J. Thompson, Oak Grove, MN (US); Dale D. Johnson, Shoreview, MN (US)

Correspondence Address: GRACO MINNESOTA INC, PO BOX 1441, MINNEAPOLIS, MN, 55440, US

(21) Appl. No.: 10/596,801

(22) PCT Filed: Dec. 30, 2004
(86) PCT No.: PCT/US04/43864

§ 371 Date: Jun. 23, 2006

Related U.S. Application Data
(60) Provisional application No. 60/534,181, filed on Jan. 2, 2004.

(51) Int. Cl. B05B 7/30

(52) U.S. Cl. 239/345; 239/346; 239/376; 239/379

(57) ABSTRACT

A texture spray gun (10), is provided with an air valve (12) design that can use several rotations of the control knob for full adjustment with smooth and steady flow change through the full range. The air shutoff (24) is integral to the fluid needle (26) actuation and consists of only two simple and inexpensive components. The body (20) of the spray gun (10) is produced as a one piece plastic piece which requires no secondary operations (after molding) to complete. The spray gun may be configured to operate with both hopper and pump feeds. A molded soft polymer one-way valve (48) is installed in the air passage (50) of the texture gun (10). A multi-hole air cap (52) is installed directly to the end of the needle of the texture gun (10) and gives a more consistent and desirable pattern than the prior art single hole arrangements.

### TECHNICAL FIELD

This application claims the benefit of U.S. Application Ser. No. 60/534,181, filed Jan. 2, 2004.

### BACKGROUND ART

Spray guns for the application of texture materials to ceilings and other surfaces in buildings have become increasingly popular. While generally efficient at applying such materials, existing texture guns have tended to be less than flexible for different applications.

Existing spray guns utilize several methods of air flow control. One method uses an external (to the gun) air valve such as a ball valve or spool valve. These valves provide uneven and limited airflow adjustment. Prior art internal air valves have also suffered from the same limitations. Air shutoff in prior art guns uses a second needle operated by the trigger in addition to the fluid needle.

Current texture guns have no provision to prevent backflow of fluid material into the air chambers of the gun requiring disassembly for cleaning or permanently damaging the gun.

### DISCLOSURE OF THE INVENTION

The new air valve design can use several rotations of the control knob for full adjustment with smooth and steady flow change through the full range. Since texture spray patterns are highly dependent on the air supplied, this higher resolution allows the user to easily find the optimum flow for the desired pattern. The valve is integral to the gun and is more protected compared to an external assembly. It can be adjusted to completely turn off airflow if desired and has markings for reference on or near the valve. The valve includes a soft seat installed in the air passage of the gun body and a stainless steel needle with a matching angle. The needle is threaded into the gun with extra fine threads. By turning the knurled end, the matching angles of the needle and seat throttle the air. The soft seat allows the valve to be completely shut and compensates for wear.

The air shutoff of the instant invention is integral to the fluid needle actuation and consists of only two simple and inexpensive components. Since these components fit over the fluid needle they can be removed for the gun to operate as a bleeder gun.

The body of the spray gun is produced as a one piece plastic piece which requires no secondary operations (after molding) to complete. The body is manufactured using gas-assisted injection molding. The fluid nozzle and hose ports both have functional molded threads. The trigger will snap fit over two protrusions on the body and body is also provided with a molded trigger stop. The trigger lock installs into two molded holes. Internally, the body has two metal inserts molded along the fluid needle axis with the rear insert providing a solid installation point for the air hose. The gun needle o-rings will operate reliably inside the inserts.

The spray gun may be configured to operate with both hopper and pump feeds. In one method of doing so, a flippable gun head may be rotated 180° to the desired orientation. When pointing up, the hopper installs with a threaded adapter and when pointing down, the hose attaches directly. To rotate the head, the user need merely loosen the locknut in front of the trigger, rotate the head and then retighten. The two locations are detented for ease of adjustment.

Another method of accommodating hose and hopper provides both ports molded integrally with the gun body. The user may either rotate the internal flow director to block the unused port or install a cap in the unused port.

The internal flow director is molded from a soft pliable plastic and creates a pressure assisted seal by flexing to seal under fluid pressure. It is installed with a slight press fit over a metal insert molded into the gun body and is captured by the fluid nozzle. The insert has an integral wiper/seal which cleans the gun needle as it retracts into the body on actuation. The flow director is oriented by a tab which keys into notches in the gun body.

A molded soft polymer one-way valve is installed in the air passage of the texture gun. Forward airflow will open the valve for normal spraying and will flow up to 40 CFM of air due to the quad-shaped design. Without airflow, the valve will relax shut and prevent fluid backflow.

A multi-hole air cap is installed directly to the end of the needle of the texture gun and gives a more consistent and desirable pattern than the prior art single hole arrangements. While prior art designs also have multi-hole designs, in those designs, the air is introduced around the outside of the fluid flow instead of through the center needle. This configuration is superior to a straight hole through the center of the needle but expensive and cannot accommodate a one-way valve. The instant invention functions like the outside air design but is less costly and allows use of the one-way valve.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a partial cutaway showing the air control system of the instant invention.

FIG. 2 is an external view of the molded gun body.

FIG. 3 is detail view of the trigger attachment of the molded gun body.

FIG. 4 is a cutaway view of the molded gun body showing the inserts

FIG. 5 shows the gun configured for hopper use.

FIG. 6 shows the gun configured for pump line use.

FIG. 7 shows a two port gun for hopper and pump use.

FIG. 8 shows the flow director configured for hopper use.

FIG. 9 shows the flow director configured for pump use.

FIG. 10 shows the flow director details.

FIG. 11 shows a front perspective view of the flow director.

FIG. 12 shows a rear perspective view of the flow director.

FIG. 13 shows the molded one-way valve.

FIG. 14 shows the multi-hole air cap.

FIG. 15 is a cross-section showing the molded one-way valve and the multi-hole air cap.

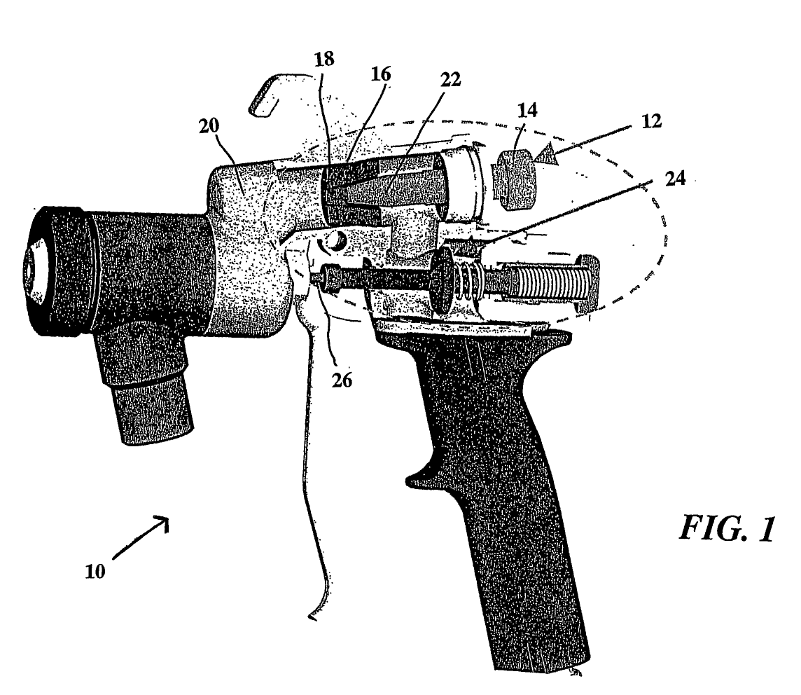

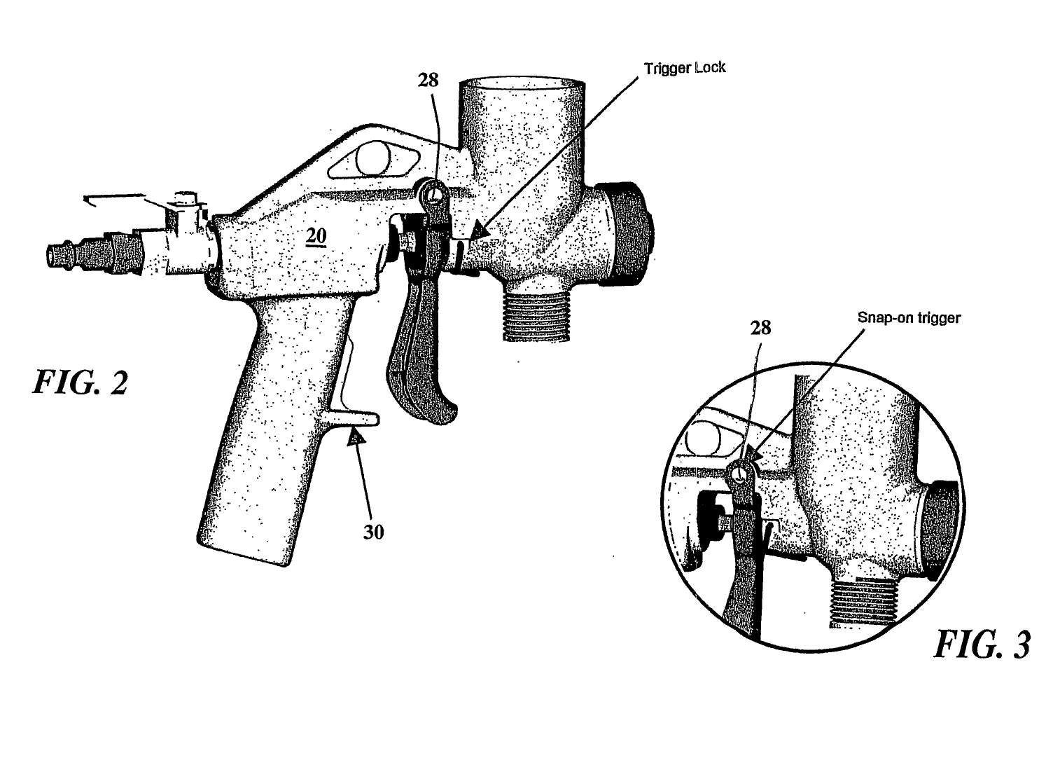

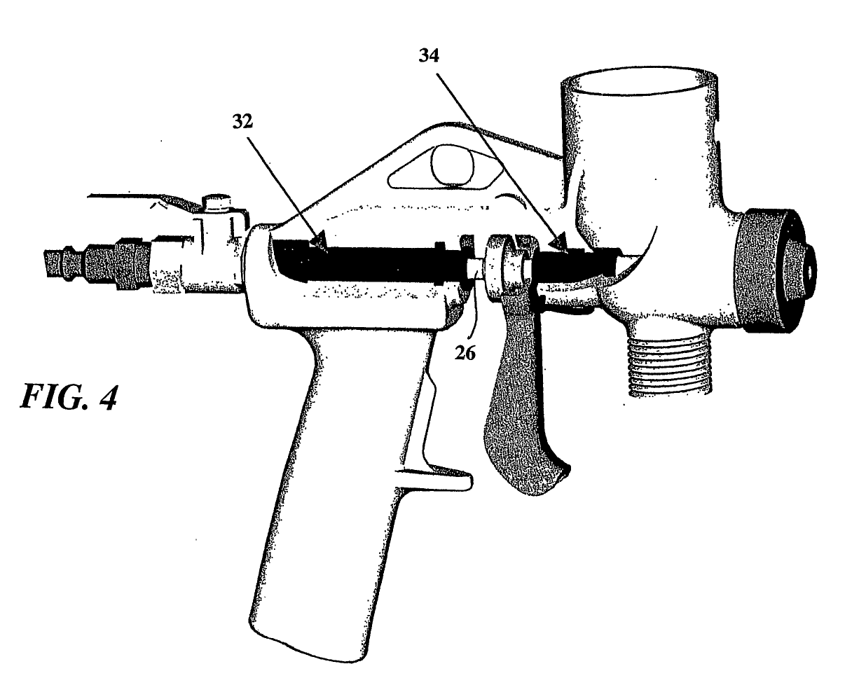

### BEST MODE FOR CARRYING OUT THE INVENTION

In the texture spray gun of the instant invention, generally designated 10, the new air valve 12 design can use several rotations of the control knob for full adjustment with smooth and steady flow change through the full range. Since texture spray patterns are highly dependent on the air supplied, this higher resolution allows the user to easily find the optimum flow for the desired pattern. The valve is integral to the gun and is more protected compared to an external assembly. It can be adjusted to completely turn off airflow if desired and has markings for reference on or near the valve. The valve includes a soft seat 16 installed in the air passage 18 of the gun body 20 and a stainless steel needle 22 with a matching angle. The needle 22 is threaded into the gun with extra fine threads. By turning the knurled knob 14, the matching angles of the needle 22 and seat 16 throttle the air. The soft seat 16 allows the valve 12 to be completely shut and compensates for wear.

The air shutoff 24 of the instant invention is integral to the fluid needle 26 actuation and consists of only two simple and inexpensive components. Since these components fit over the fluid needle 26 they can be removed for the gun to operate as a bleeder gun.

The body 20 of the spray gun 10 is produced as a one piece plastic piece which requires no secondary operations (after molding) to complete. The body is manufactured using gas-assisted injection molding. The fluid nozzle and hose ports both have functional molded threads. The trigger will snap fit over two protrusions 28 on the body 20 and body 20 is also provided with a molded trigger stop 30. The trigger lock installs into two molded holes. Internally, the body has two metal inserts 32 and 34 molded along the fluid needle 26 axis with the rear insert 32 providing a solid installation point for the air hose. The gun needle o-rings will operate reliably inside the inserts 32 and 34.

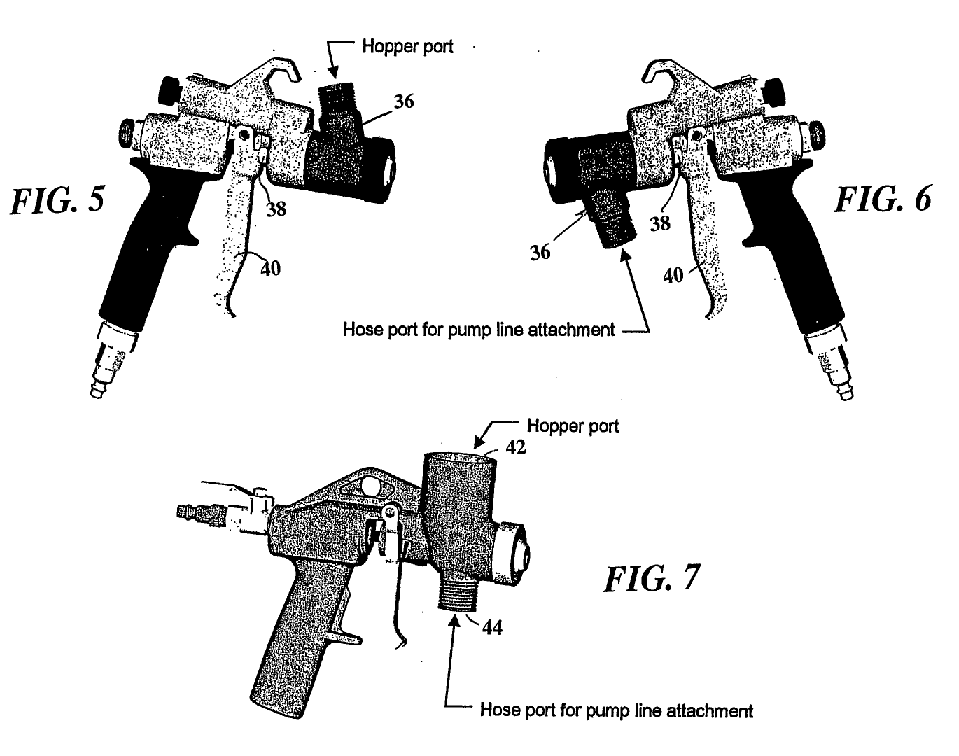

The spray gun may be configured to operate with both hopper and pump feeds as shown in FIGS. 5 and 6. In one method of doing so, a flippable gun head 36 may be rotated 180° to the desired orientation. When pointing up as shown in FIG. 5, the hopper (not shown but conventional) installs with a threaded adapter and when pointing down (FIG. 6), the hose attaches directly. To rotate the head 36, the user need merely loosen the locknut 38 in front of the trigger 40, rotate the head and then retighten. The two locations are detented for ease of adjustment.

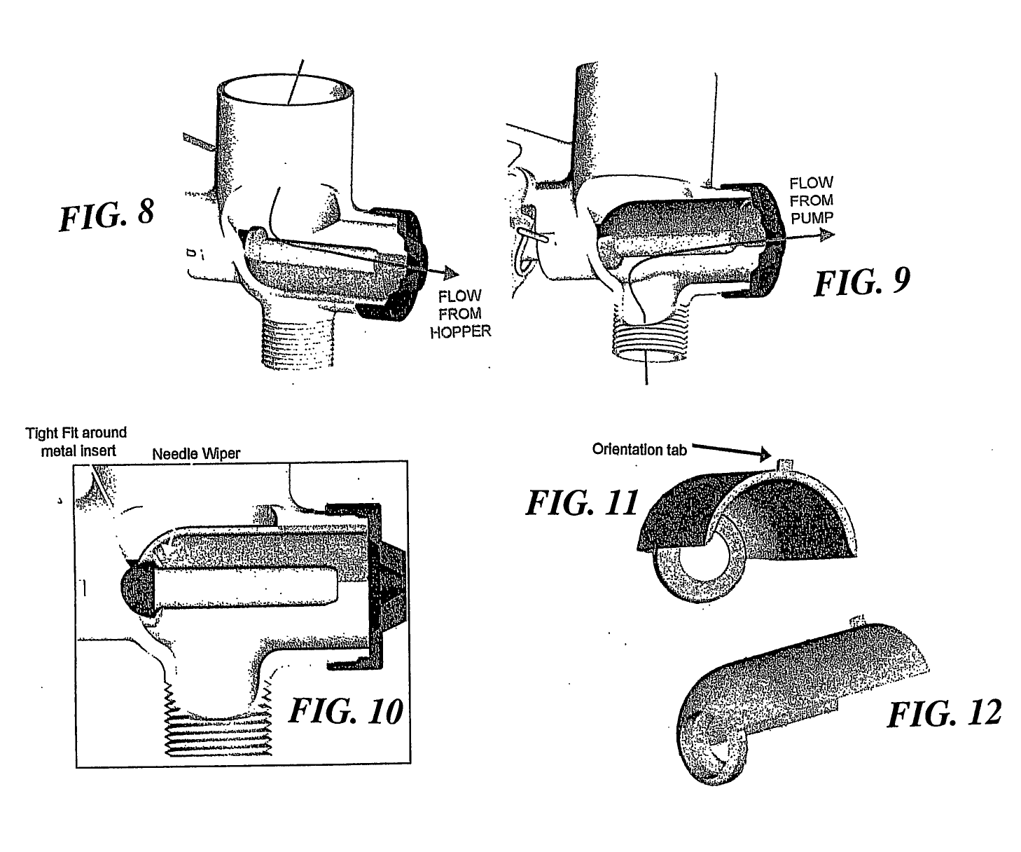

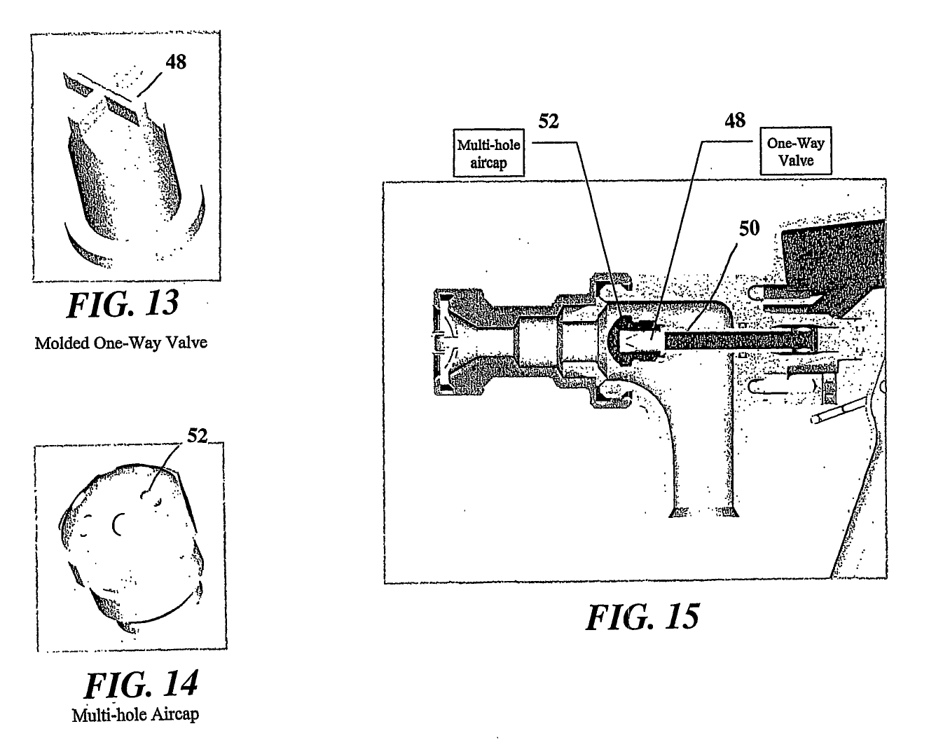

Another method of accommodating hose and hopper shown in FIGS. 7-12 provides both ports 42 and 44 molded integrally with the gun body 20. The user may either rotate the internal flow director 46 to block the unused port or install a cap in the unused port.

The internal flow director 46 is molded from a soft pliable plastic and creates a pressure assisted seal by flexing to seal under fluid pressure. It is installed with a slight press fit over a metal insert 34 molded into the gun body 20 and is captured by the fluid nozzle. The insert has an integral wiper/seal which cleans the gun needle as it retracts into the body on actuation. The flow director 46 is oriented by a tab which keys into notches in the gun body 20.

A molded soft polymer one-way valve 48 is installed in the air passage 50 of the texture gun 10. Forward airflow will open the valve 48 for normal spraying and will flow up to 40 CFM of air due to the quad-shaped design. Without airflow, the valve 48 will relax shut and prevent fluid backflow.

A multi-hole air cap 52 is installed directly to the end of the needle of the texture gun 10 and gives a more consistent and desirable pattern than the prior art single hole arrangements. While prior art designs also have multi-hole designs, in those designs, the air is introduced around the outside of the fluid flow instead of through the center needle. This configuration is superior to a straight hole through the center of the needle but expensive and cannot accommodate a one-way valve 48. The instant invention functions like the outside air design but is less costly and allows use of the one-way valve 48.

It is contemplated that various changes and modifications may be made to the texture spray gun without departing from the spirit and scope of the invention as defined by the following claims.

1. A spray gun for applying texture materials and having a body, an air valve and an air passage, the improvement comprising said air valve comprising:
a needle having a diameter, a seating surface and threadedly located in said body, said threads being relatively fine; and
a seat having a seating surface, said needle and seat seating surfaces having lengths at least as great as about said diameter.

2. A spray gun for applying texture materials and having a body, a fluid needle and an air passage, the improvement comprising an air shutoff valve, said valve comprising a member mounted over said needle for occluding said air passage.

3. A spray gun for applying texture materials and having a body, the improvement comprising said body being molded as a one piece plastic piece requiring no secondary operations to complete.

4. The spray gun of claim 3 further comprising two protrusions on said body for mounting a trigger and a molded trigger stop.

5. A spray gun for applying texture materials and having a body, the improvement comprising a gun head rotatably attached to said body for rotation between a first position for mounting a hopper and a second position for attachment to a pump line.

6. A spray gun for applying texture materials and having a body, the improvement comprising said body having first and second ports for receiving a source of material, said first port being positioned for mounting a hopper and said second port being positioned for attachment to a pump line.

7. The spray gun of claim 6 further comprising an internal flow director 46 for selective occlusion of one of said ports.

8. A spray gun for applying texture materials and having a body and an air passage, the improvement comprising a molded soft polymer one-way valve installed in said air passage allowing only forward airflow for normal spraying and which without airflow will relax shut and prevent fluid backflow.

9. A spray gun for applying texture materials and having a body and a needle having an air passage therethrough, the improvement comprising a multi-hole air cap installed directly to the end of the needle.
